(19) United States
(12) Patent Application Publication
(10) Pub. No.: US 2006/0123451 A1
(43) Pub. Date: Jun. 8, 2006

(54) Enhanced content in an on-demand environment

(75) Inventor: David Preisman, New York, NY (US)

Correspondence Address: VENABLE LLP, P.O. BOX 34385, WASHINGTON, DC, 20045-9998, US

(73) Assignee: Showtime Networks Inc., New York, NY (US)

(21) Appl. No.: 11/004,802

(22) Filed: Dec. 7, 2004

(51) Int. Cl. H04N 7/173

(52) U.S. Cl. 725/86

(57) ABSTRACT

A system, method and computer program product for providing enhanced interactive content about programming services in, e.g., a video on demand (VOD), subscription VOD, personal video recorder (PVR), or digital video recorder (DVR) environment is disclosed. The programming services may include movies, original series, sports and/or family programming. The interactive interface provides the ability to interact and/or access an extraordinary amount of content about a program being accessed. The interactive interface also provides an easy, entertaining viewing experience and/or provides viewers with choice, control and/or convenience that they desire.

### BACKGROUND OF THE INVENTION

Content such as television programming may include, e.g., a programming service. An example of a programming service is a subscription programming service, such as, e.g., SHOWTIME, available from SHOWTIME NETWORKS INC. of New York, N.Y., USA. Content providers offer programming services as a product. An example of a content provider is, e.g., SHOWTIME NETWORKS INC. Content distributors may own communication networks that may be used to distribute programming content. An example of a content distributor is, e.g., COMCAST CORPORATION of Philadelphia, Pa., USA, DIRECTV of El Segundo, Calif., USA, ECHOSTAR COMMUNICATIONS CORPORATION of Englewood, Colo., USA, and TIME WARNER CABLE of Stamford, Conn., USA. Conventionally, content is distributed over various network platform types including, e.g., voice, data, cable television (CATV), wireless communications networks, satellite television, direct broadcast satellite television, multichannel multipoint distribution service (MMDS) and wireless fidelity (WI-FI).

A large number of programming services can be provided to a viewer. The amount of channels a viewer has access to may number in the hundreds. With the advent of on demand programming, an ever increasing amount of programming is available to viewers. Programming guides have been introduced to help the viewer navigate through the large number of programming services available. Programming guides also provide information about a program being viewed. However, conventional programming guides only provide brief summary information about a program while the program is being viewed. Program guides may, e.g., provide a single sentence summary of a program being viewed, and perhaps a rating, a lead actor, and in the case of a linear program, the start time of the program. Moreover, conventional programming guides do not allow interactive access to further, more in depth, information about programming. As video on demand (VOD), subscription VOD (SVOD), and programming accessible from digital video recorders (DVRs) (such as, e.g., a DVR available from TIVO INC. of Alviso, Calif., USA), and the like, have become more common place, programs can now be recorded, paused, and/or viewed as convenient for the viewer. The air time of a program is not a determining factor in what program to view. Further, viewing need not be continuous, and may be interrupted, and resumed as convenient for the viewer. Also, with widespread use of the Internet, viewers have increasingly become used to interactive searching of information, so-called “surfing,” allowing ad hoc, access to additional linked information on areas of interest to the viewer. Thus, viewers desire more in-depth information about programs and movies while engaged in the viewing experience than is conventionally provided by, e.g., programming guides.

What is needed then is an improved technique of accessing enhanced content during viewing of a program that overcomes shortcomings of conventional solutions.

### SUMMARY OF THE INVENTION

An interactive interface according to various exemplary embodiments of the present invention are set forth below. An exemplary embodiment of the present invention may be directed to a system, method and machine-readable medium for providing programming information, including: receiving a request for interactive content about on demand programming; and providing an interactive interface including the interactive content about the on demand programming while a user is accessing the on demand programming. Other exemplary, but non-exhaustive embodiments of the system, method, and machine-readable medium include the below illustrated list of features described with reference to exemplary method based embodiments.

In an exemplary embodiment, the method may include receiving the request for interactive content about the on demand programming, the on demand programming comprising video on demand (VOD), or subscription VOD on demand programming. Other examples of on demand programming include programming accessed from, or facilitated by, a client cache, a media stream, a digital video server, a client stored program, or a digital video recorder (DVR), on demand programming. A DVR may provide access to programming such as, e.g., but not limited to, programming delivered to a DVR for use in a DVR-pre-cached video on demand environment, or also programs recorded to the DVR by a consumer.

In an exemplary embodiment, the method may include providing the interactive interface including the interactive content relating to the on demand programming, the interactive content may be viewed fullscreen, or in an overlay. In an exemplary embodiment, the on demand programming may be hidden, or viewed fullscreen, or in a picture in picture (PIP) window.

In an exemplary embodiment, the method may include providing the interactive interface including the interactive content relating to the on demand programming while the on demand programming is being experienced (including, e.g., being viewed), being fast forwarded, being rewound, or being paused.

In an exemplary embodiment, the method may include providing the interactive interface where the interactive content may include information synchronized or not synchronized with the on demand programming.

In an exemplary embodiment, the method may include providing the interactive interface including the interactive content comprising information relating to: the on demand programming, a programming service, other on demand programming, a programming scene, and/or a point in time.

In an exemplary embodiment, the method may include accessing the interactive content including synchronized information including: embedding a trigger in the on demand programming to access the interactive content.

In an exemplary embodiment, the method may include accessing the interactive content including synchronized information including: embedding a trigger in a video file of the on demand programming that communicates at various point in the video with an external interactive (ITV) application to initiate a certain action.

In an exemplary embodiment, the method may include accessing the interactive content including synchronized information including: accessing the interactive content based on a time reference in a video file, or an elapsed time from program start.

In another exemplary embodiment, the providing of the interactive content may include providing an interactive application adapted to read the time reference in the video file, or the elapsed time from program start; and adapted to read a playlist of a plurality of events; and wherein the accessing may include executing an event of the plurality of events associated with the time reference, or the elapsed time.

In another exemplary embodiment, the providing of the interactive content including synchronized information may include embedding an application in a video signal of the on demand programming.

In an exemplary embodiment, the method may include providing the interactive content that may include providing enhanced information content that may include: providing a biography of a person associated with the on demand programming; providing a filmography of a person associated with the on demand programming; providing a character description of a character of the on demand programming; providing award information relating to the on demand programming; providing a soundtrack of the on demand programming; providing trivia of the on demand programming; providing audio information relating to the on demand programming, service, or network; providing video information relating to the on demand programming, service, or network; providing information relating to subject matter of the on demand programming being accessed; providing information relating to a network, package of networks, a programming service, or a promotion; and/or providing promotional information that may include audio or video for a nonsubscriber relating to the on demand programming. In addition, the information could also include offering programming to a nonsubscriber.

In another exemplary embodiment, the providing of the interactive content may include providing promotional information targeted based on subscription status.

In another exemplary embodiment, the providing promotional information may include identifying a subscription status of a viewer; allowing the viewer to access the interactive content in accordance with subscription status; presenting an offer to a nonsubscriber; or receiving an order accepting the offer from the nonsubscriber.

In another exemplary embodiment, the providing of the interactive content may include promoting other content, another program, an on demand service, a network, a package of networks, a feature, or a promotion, from the on demand programming.

In another exemplary embodiment, the providing of the interactive content may include providing targeted interactive content to a viewer of the on demand programming.

In another exemplary embodiment, the accessing of the on demand programming may include viewing the on demand programming; engaging in a viewing experience of the on demand programming; fast forwarding the on demand programming; rewinding the on demand programming; pausing the on demand programming; or playing the on demand programming.

In an exemplary embodiment, the method may include the providing of interactive content may include providing interactive components that may include: providing trivia relating to the on demand programming; providing a quiz relating to the programming; providing a postcard generator related to the on demand programming; providing polling relating to the on demand programming; and/or providing gaming relating to the on demand programming.

In an exemplary embodiment, the method may include providing the interactive content that may include providing an enhanced audio video (A/V) experience that may include: providing a video track or an alternate video track, the alternate video track may include an alternate camera angle track, an alternate resolution track, an alternate video special effects track, a subtitle video track, and/or an alternate ratings video track for the on demand programming; providing an audio track, or an alternate audio track, where the alternate audio track may include an alternate language audio track, an alternate audio special effect track, and/or an alternate audio format track, for the on demand programming; providing a promotional audio/video track that may be targeted based on subscription status of a viewer; providing a commentary relating to the on demand programming; and/or providing deleted scenes relating to the on demand programming.

In an exemplary embodiment, the method may further include sending a playlist to a client to enable a two-screen experience synchronizing information between the client and the programming.

In an exemplary embodiment, sending the playlist to the client may include: sending the playlist to: a tablet, a personal computer (PC), a handheld, a personal digital assistant (PDA), a mobile phone, a remote screen, a remote control, and/or a browser.

In another exemplary embodiment, the method may include sending a playlist including sending an updated playlist based on a state of play or pause of the on demand programming, or a timecode in the programming.

In an exemplary embodiment, the method may include receiving a request that may include: receiving a request from a user wherein the user comprises at least one of a subscriber and a nonsubscriber.

In another exemplary embodiment, the method may include providing the interactive content including providing the interactive content targeted based on the on demand programming being accessed.

In an exemplary embodiment, the method may include providing the interactive interface for nonsubscribers that may include: presenting a subscription offer; and/or receiving a subscription order in response to the subscription offer.

Further features and advantages of the invention, as well as the structure and operation of various embodiments of the invention, are described in detail below with reference to the accompanying drawings.

### BRIEF DESCRIPTION OF THE DRAWINGS

The foregoing and other features and advantages of the invention will be apparent from the following, more particular description of exemplary embodiments of the invention, as illustrated in the accompanying drawings. In the drawings, like reference numbers generally indicate identical, functionally similar, and/or structurally similar elements. A preferred exemplary embodiment is discussed below in the detailed description of the following drawings:

FIG. 1 depicts an exemplary embodiment of an interactive television environment according to an exemplary embodiment of the present invention;

FIG. 2A depicts an exemplary embodiment of an interactive television client according to an exemplary embodiment of the present invention;

FIG. 2B depicts an exemplary embodiment of an interactive television according to an exemplary embodiment of the present invention;

FIG. 3A depicts a main introductory screen according to an exemplary embodiment of the present invention;

FIG. 3B depicts an on now screen for an exemplary movie program screen according to an exemplary embodiment of the present invention;

FIG. 4 depicts an exemplary insider screen including an exemplary three section list of information, according to an exemplary embodiment of the present invention;

FIGS. 5A-5C depict exemplary postcard screens illustrating exemplary reminder and TV postcards that may be sent according to an exemplary embodiment of the present invention;

FIG. 6 depicts an exemplary computer system that may be used in implementing an exemplary embodiment of the present invention;

FIG. 7A depicts an exemplary movie screen summary according to an exemplary embodiment of the present invention;

FIG. 7B depicts an exemplary movie cast screen according to an exemplary embodiment of the present invention;

FIG. 7C depicts an exemplary filmography screen according to an exemplary embodiment of the present invention;

FIG. 8 depicts an exemplary soundtrack screen for an exemplary movie program according to an exemplary embodiment of the present invention; and

FIG. 9 depicts an exemplary extra information screen for accessing interactive enhanced content or information according to an exemplary embodiment of the present invention.

### DETAILED DESCRIPTION OF EXEMPLARY EMBODIMENTS OF THE PRESENT INVENTION

A preferred embodiment of the invention is discussed below as well as various other exemplary, but non-limiting embodiments. While specific implementations are discussed, it should be understood that this is done for illustration purposes only. A person skilled in the relevant art can recognize that other components and configurations may be used without parting from the spirit and scope of the invention.

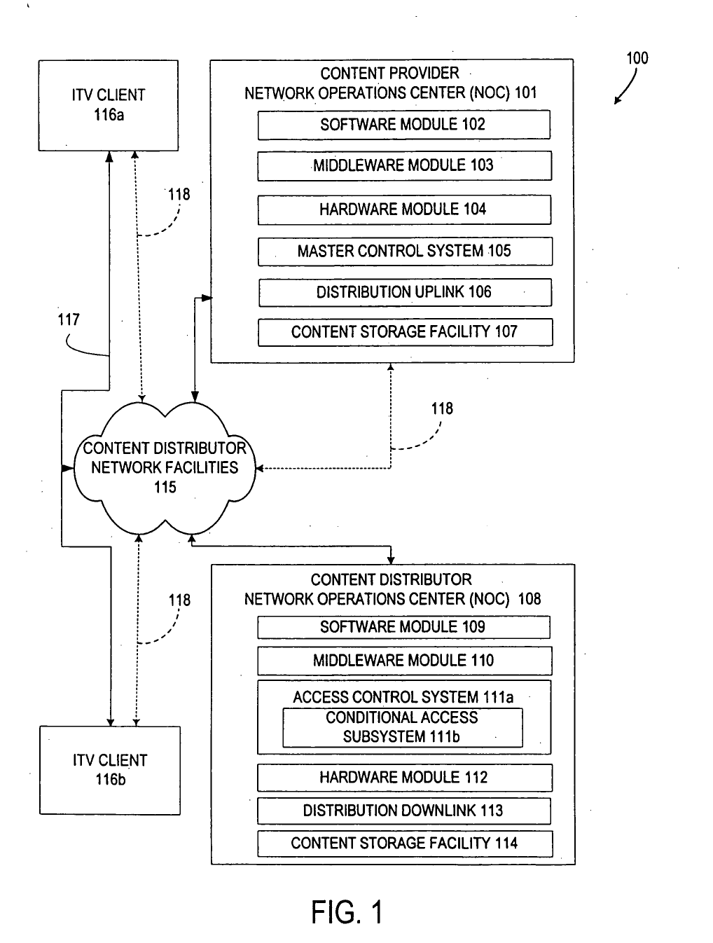

FIG. 1 depicts an exemplary embodiment of an interactive television (ITV) environment 100 that can be used to provide an enhanced interactive program information interface (“interactive interface”) according to an exemplary embodiment of the present invention. Although described below in a particular environment, the interactive interface may be implemented in a variety of other environments.

ITV environment 100 in an exemplary embodiment may include a content provider network operation center (NOC) 101, a plurality of ITV clients 116a, 116b, and a content distributor NOC 108. The content provider NOC 101, ITV clients 116a-b, and content distributor NOC may be coupled to one another by content distributor network facilities 115. The ITV environment 100 of FIG. 1 also illustrates, in an exemplary embodiment, a distribution channel 117 that may be used to broadcast content to the ITV clients 116a, 116b from the content providers over the content distribution network 115, and a backchannel 118 that may be used to receive interactive responses from the ITV clients 116a, 116b at, e.g., the content provider. The back channel 118 may be in an inband, or out of band channel. The back channel 118 may be separate from the distribution channel 116. The back channel 118 may use circuit connections, or packet switched communication.

Content provider NOC 101 may include, e.g., a software module 102 and a middleware module 103 running on top of a hardware module 104. The hardware module 104 may include, e.g., a processor and associated memory. The content provider NOC 101 may also include a master control system 105 that may be used to assemble portions of programming service content for distribution. The portions of programming service content may be accessed using various known methods from a content storage facility 107, onto which the content may have been previously stored. The content provider NOC 101 may also include a distribution uplink 106 that may be used to upload content to the content distributor for distribution to ITV clients 116a, 116b. Of course, the content provider in another exemplary embodiment, may communicate directly with ITV clients 116a, 116b. For example, the clients 116a, 116b may communicate via a communications link directly to the content provider via a protocol such as, e.g., but not limited to, simple mail transport protocol (SMTP), hyper text markup protocol (HTTP), Internet Protocol (IP), transmission control protocol/IP (TCP/IP), etc.

Content distributor NOC 108 can include a software module 109, a middleware module 110, and an access control system 111a including, e.g., a conditional access subsystem 111b, running on a hardware module 112. A distribution downlink 113 can be used, in an exemplary embodiment, to download content from the content providers to the content distributor NOC 108, for temporary storage in content storage facility 114, prior to distribution directly to, or via the content distributor network 115, to ITV clients 116a, 116b for viewing by viewers.

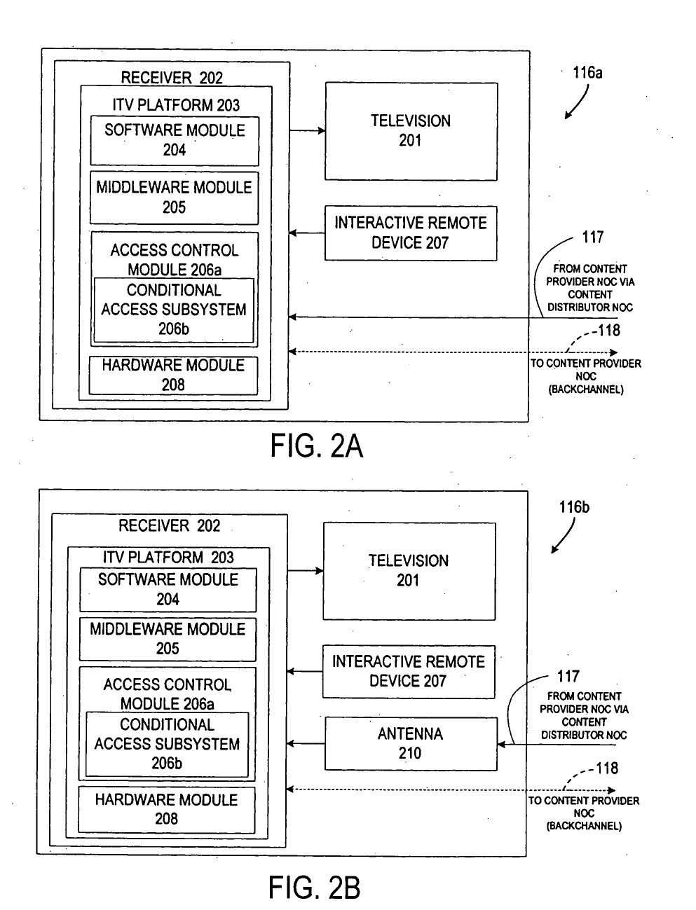

As shown in FIG. 2A, ITV client 116a may include, in an exemplary embodiment, a television 201, a receiver 202, and an interactive remote device 207 such as a remote control. Receiver 202 can include, in an exemplary embodiment, ITV platform 203 that can include, e.g., a software module 204, a middleware module 205, an access control module 206a including, e.g., a conditional access subsystem 206b (such as a smart card), and hardware module 208. The hardware module 208 may include a processor and associated memory. The various modules may be combined into a set-top box. The set-top box may be configured to record programming services. As shown in FIG. 2A, receiver 202 can be configured to receive content from content provider NOC 101 via, e.g., a content distributor network 115 and content distributor NOC 108, or directly via interface equipment, for example. The ITV platform 203 of FIG. 2A can be thought of as an example environment that could be used for a content distributor that uses a cable television (CATV) or a video over IP television (IPTV) network. Content may be distributed to ITV 116a, 116b from the content provider over content distributor facilities as shown in line 117. Dotted line 118 represents an exemplary back channel 118 for sending interactive information to the content provider. The back channel is typically provided via a phone modem, 2-way cable, or via access to broadband. Alternatively, as is shown in FIG. 2B, receiver 202 can be configured to receive content from content provider NOC 101 via content distributor network 115 and content distributor NOC 108 via antenna 210, such as a satellite dish or the like.

The interactive television system described herein is exemplary only. The invention can also be implemented in many other types of interactive systems. For example, the content provider may communicate directly with the ITV clients 116a. Programming services, video and interactive television content may be provided directly to the viewer. Also, a back channel may be provided directly from the ITV client 116a to the content provider, without passing through a content distributor. A back channel is not necessary in all embodiments of the invention.

As will be understood by a person having ordinary skill in the art, content provider NOC 101 can distribute content via distribution uplink 106 to content distributor NOC 108. Content distributor NOC 108 can receive the content from content provider NOC 101 via distribution downlink 113. Content distributor NOC 108 can then distribute content to ITV clients 116a, 116b through content distributor network facilities 115 or over the Internet for IPTV. Examples of content distributors include, e.g., COMCAST CORPORATION of Philadelphia, Pa., USA, DIRECTV of El Segundo, Calif. USA, ECHOSTAR COMMUNICATIONS CORPORATION of Englewood, Colo., USA, and TIME WARNER CABLE of Stamford, Conn. USA. Conventionally, content may be distributed over various network platform types including voice, data, cable television (CATV), wireless communications networks, direct broadcast satellite television, multichannel multipoint distribution service (MMDS), IPTV, wireless fidelity (WI-FI), etc.

The content provided to the ITV clients 116A may include on demand programming from a variety of sources, or accessed or facilitated by any of a number of well known access methods. Types of programming services which may be provided include, e.g., but not limited to, various on demand programming services. Exemplary forms of on demand services include, e.g., but are not limited to, a video on demand (VOD) service, a subscription VOD (SVOD) service, etc. Other on demand services may include programming services accessible by any of various digital video recorders (DVRs) by which a viewer can record and view digital video content or access preloaded video content. The interactive interface according to an exemplary embodiment of the present invention, may provide enhanced interactive information content regarding a programming services that are being concurrently viewed. The information content may be provided such that, e.g., the video being viewed may be, e.g., hidden, or shown in a picture in picture (PIP) window, or fullscreen. The interactive content may be provided, in an exemplary embodiment, as an overlay, or fullscreen. The video may be interrupted, paused, fast forwarded, rewinded, or may continue to be viewed while the enhanced interactive content is viewed by the viewer. The viewer can interact with content while the programming may be playing, hidden, fast forwarded, rewinded, or paused, for example. An exemplary programming service program may include, e.g., a movie, or a series, that may be made available by a programming service such as, e.g., Showtime, The Movie Channel, The Sundance Channel, etc., which are available from SHOWTIME NETWORKS INC. of New York, N.Y., USA. On demand programs may also include, e.g., VOD and SVOD programs, and programs accessible from DVRs, among other well known devices. Viewers that have advanced set top boxes may be able to access robust digital video recording and playback capabilities, as well as set reminders to view programs.

The interactive interface provides a user, or viewer, the ability to interact and access an extraordinary amount of content relating to a program being viewed. For example, the interactive interface can also act as an access interface for accessing enhanced information content, such as, e.g., textual content, production credits, filmographies, character descriptions, award information, genre information, information relating to audio, information relating to video, and promotional information for nonsubscribers, etc. The interactive interface may be used to access interactive components such as, e.g., but not limited to, trivia, quiz, postcards, polling, gaming, etc. The interactive interface may be used to provide access to alternative audio/video (AV) experience such as, e.g., but not limited to, alternate video and audio tracks, including e.g., alternate resolution tracks, interviews, “making of” videos, behind the scenes clips, trailers, alternate camera angle tracks, alternate special effects, alternate subtitles, ratings tracks, foreign language tracks, promotional tracks, closed captioning, director commentary, deleted scenes tracks, etc. Further, the interactive interface can provide for access to information in a synchronized, two screen experience, by sending a playlist down to a second client device. Various video assets may be displayed via the interactive interface. The video may originate from, e.g., a VOD or SVOD server, a DVR, a storage device, or hard drive on a client device, or IP delivery, etc. The interactive interface may also provide an easy, entertaining television viewing experience and may provide viewers choice, control and convenience that they desire. An example of an interactive interface and an exemplary but non-limiting format are described in more detail below. Of course, other ways of presenting added value content and other services may also possible within the scope of the invention.

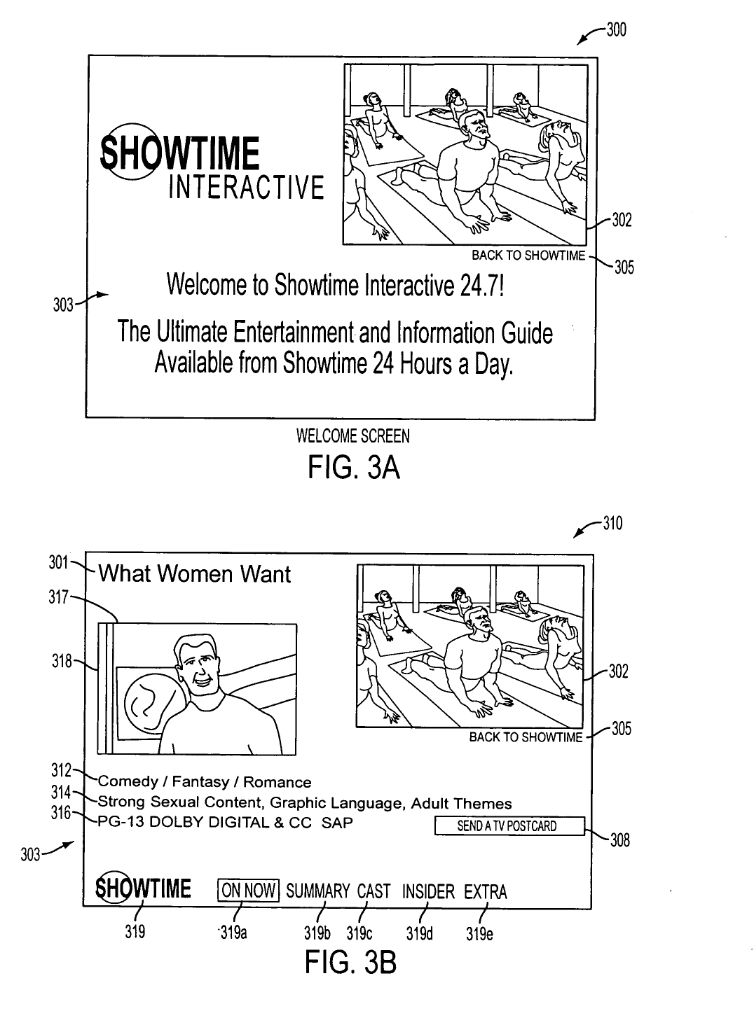

A viewer may enter the interactive interface by selecting an appropriate feature of function of their ITV client 116A, such as, e.g., but not limited to, selecting an “i” information, or other button on a set top box. Alternatively, the interactive interface may be accessed through another button (or combination of buttons) on a remote control, through an on screen navigation, from an on demand programming viewing experience, or a user interface experience, among many others. A main information screen for the interactive interface may be presented to the viewer. An example of a main screen 300 is shown in FIG. 3A. The main screen 300 may serve as an introduction to the interactive interface and may also present promotional material to the viewer. The main screen 300 may introduce the viewer to the interactive interface and may provide a picture-in-picture (PIP) image 302 of the program being viewed, as well as a content area 303. From the introductory or welcome screen, an “On Now” screen as shown in exemplary FIG. 3B, may be shown next. A return (or back) button 305 may be used to return to viewing the programming in PIP window 302, if the content is paused, return button 305 may also unpause the video programming or prompt the viewer to determine whether to unpause the programming. In an exemplary embodiment, enhanced information content may be viewed while the video is being viewed or accessed in the PIP window 302. In another exemplary embodiment, the video may be paused while enhanced information is being viewed.

FIG. 3B depicts an exemplary on now screen 310 for a program such as, e.g., a movie, or other series, or non-series on demand programming. Other non-series programs might include, e.g., an event, a live event, a one-time program such as, e.g., an awards program, a sporting event, etc. A primary navigation bar 319 and the secondary navigation bar 317 (in position shown, but not included in the exemplary screen shown in FIG. 3B) may be included on the on now screen to allow interactive access to enhanced information content relating to the program being viewed. The primary and secondary navigation bars 319, 317 may be the main means of navigation through the interactive interface and may be displayed on any of the screens described below. In some cases, additional buttons may be shown to access additional content, and may be referred to individually. For example, FIG. 3B may include additional navigation buttons 303-308. The primary and secondary navigation bars 319, 317 may allow a subscriber to access enhanced information relating to programming being viewed (or otherwise accessed). In an exemplary embodiment, during, e.g., but not limited to, a preview weekend, non-subscribers might be provided, e.g., but not limited to, an ability to subscribe to a non-subscribed program, or programming service. The primary focus of the main screen 300 may be content area 303, and picture-in-picture (PIP) window 302. Content area 303 can provide various enhanced informational content relating to the program being viewed in PIP window 302. For example, the content area 303 may include promotional messages for non-subscribers during non-subscriber viewing of subscription programming or free weekends, etc., or can contain imagery, supporting text, a channel logo, textual information, and linkable buttons to obtain more information, etc. The enhanced content information of on now non-series screen 310 shown in FIG. 3B is information for a particular movie, entitled “What Women Want” as shown in title 301, being presently viewed by the viewer, and shown in PIP window 302. Content area 303 may include, e.g., but not limited to, an image 318, that may be a still image, from the programming and accompanying textual information such as, e.g., but not limited to, a summary of the movie. Content area 303 may also display video or include a link to view video, such as, e.g., but not limited to, deleted scenes, outtakes, alternate tracks such as, e.g., camera tracks.

The type of information presented to the viewer via the main screen 300 or on now screen 310 may be tailored to the viewer. In fact, any and all screens may be targeted to the viewer. For example, the interactive content and the viewing experience may be targeted depending on whether the viewer is a subscriber or a non-subscriber. For example, for a nonsubscriber, a promotion, for example, may be offered. Promotions may be targeted based on demographic, or psychographic behaviors observed, such as, e.g., based on the on demand programming being accessed, etc. If the viewer has a set-top box, the smartcard in the set-top box may be queried in order to determine a subscription status. Additionally, the subscription status may be obtained from the content distributor. The content presented on the screens 300, 310 may then be altered accordingly. A first set of content may be provided to subscribers and a second set of content may be provided to non-subscribers. The first set of content may include, e.g., but is not limited to, added value content such as, e.g., behind the scenes information, trivia, quiz, gaming, filmographies, etc. The content may also enable a subscriber to initiate recording or playback of an on demand program. The second set of content may be tailored to the non-subscriber and may include, e.g., but not limited to, marketing and promotional materials. The system may also include an upgrade, promotion, or order button. The second set of content may be focused on getting the non-subscriber to become a subscriber. Thus, during viewing of non-subscribed programming or accessing of programming during free promotions, a non-subscriber could be provided promotions without bothering a subscriber with the same promotional content. In another exemplary public television programming embodiment, once a viewer has paid a subscription fee, then promotional offerings would be replaced with the full service or full program offering.

In order to provide an easy navigation system, the content available on the interactive interface may be organized into different sections in a convenient menu displayed in the primary navigation bar 319. As shown in FIG. 3B, on now screen 310 may include on a primary navigation bar 319, an on now button, a summary button for accessing a summary relating to the program being viewed, a cast button for accessing cast or production credit information, and an insider button for accessing further information relating to the program being viewed. Using the interactive interface described, the viewer can select one of buttons to obtain more information in corresponding to the selected button relating to the program being viewed. The viewer can navigate the screen 310 and select desired information using the remote control in a known manner. Once the viewer selects a button, the viewer may be presented with an information screen corresponding to the button.

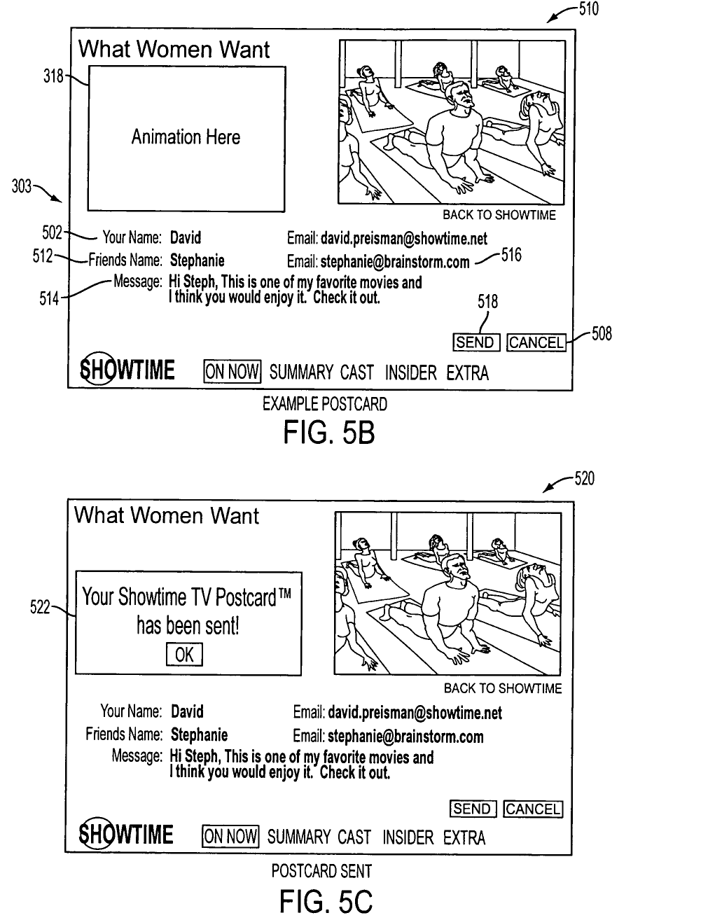

The on now screen 310 of FIG. 3B may include various information depicted in content area 303 relating to the programming viewed in window 302. As shown, content area 303 may include, e.g., PIP window 302, send a TV postcard 308, genre categor(y/ies) 312, rating and content information 314, advanced information 316 (such as, e.g, but not limited to, rating, DOLBY® sound, closed captioning (CC), secondary audio programming (SAP), etc.), title 301, and image 318. The TV postcard button 308 is described further below with reference to FIGS. 5B and 5C. The on now screen may also of course show information available about a series, and/or an episode of a series for series type on demand programming.

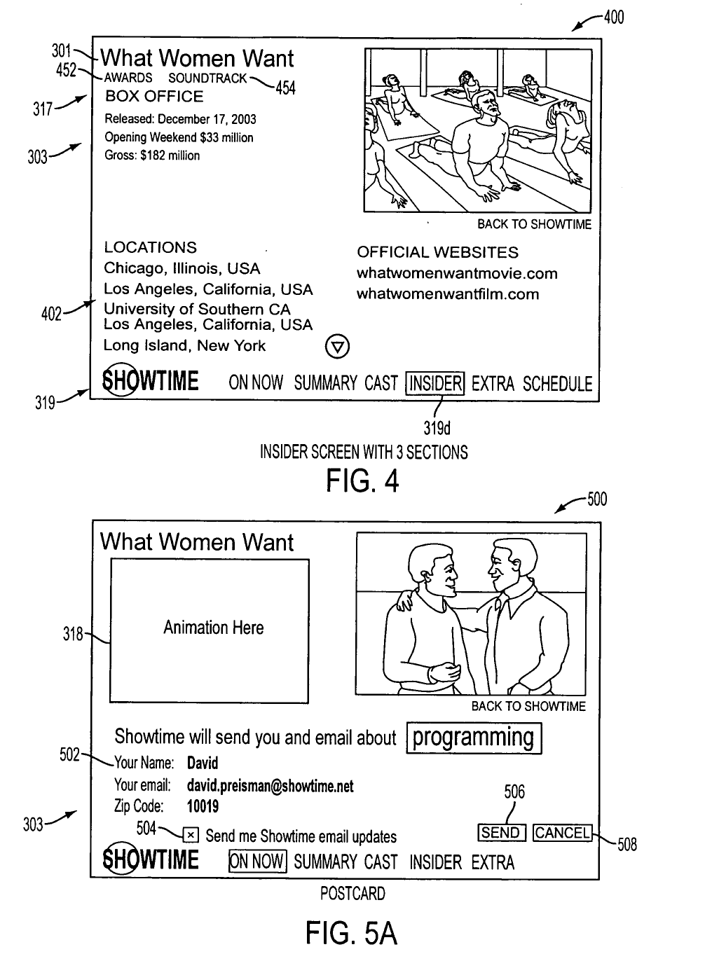

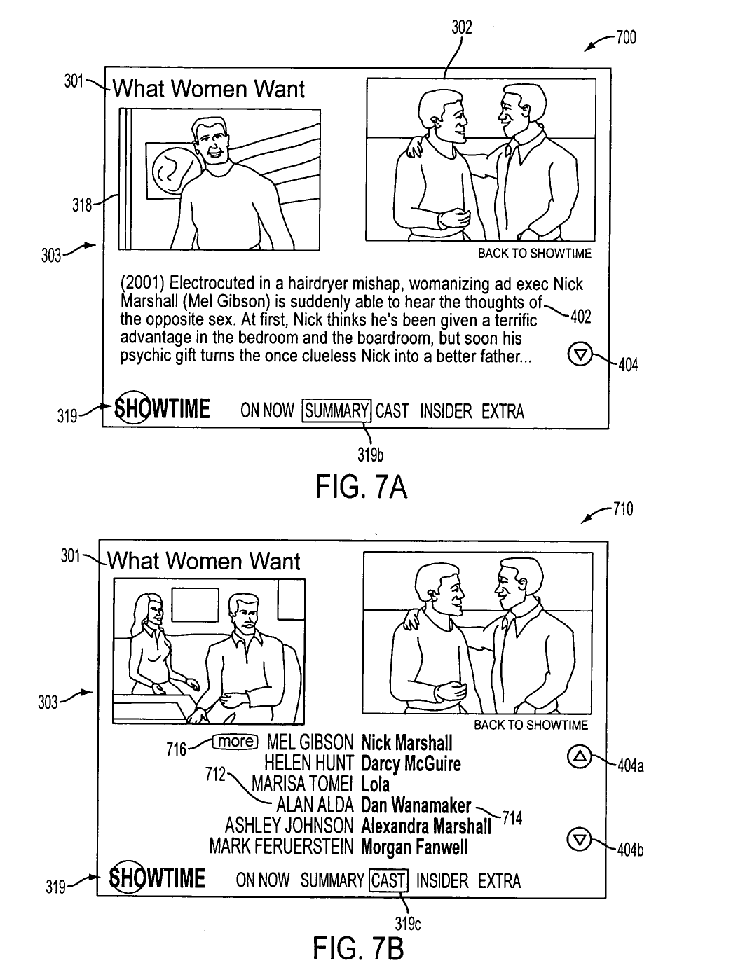

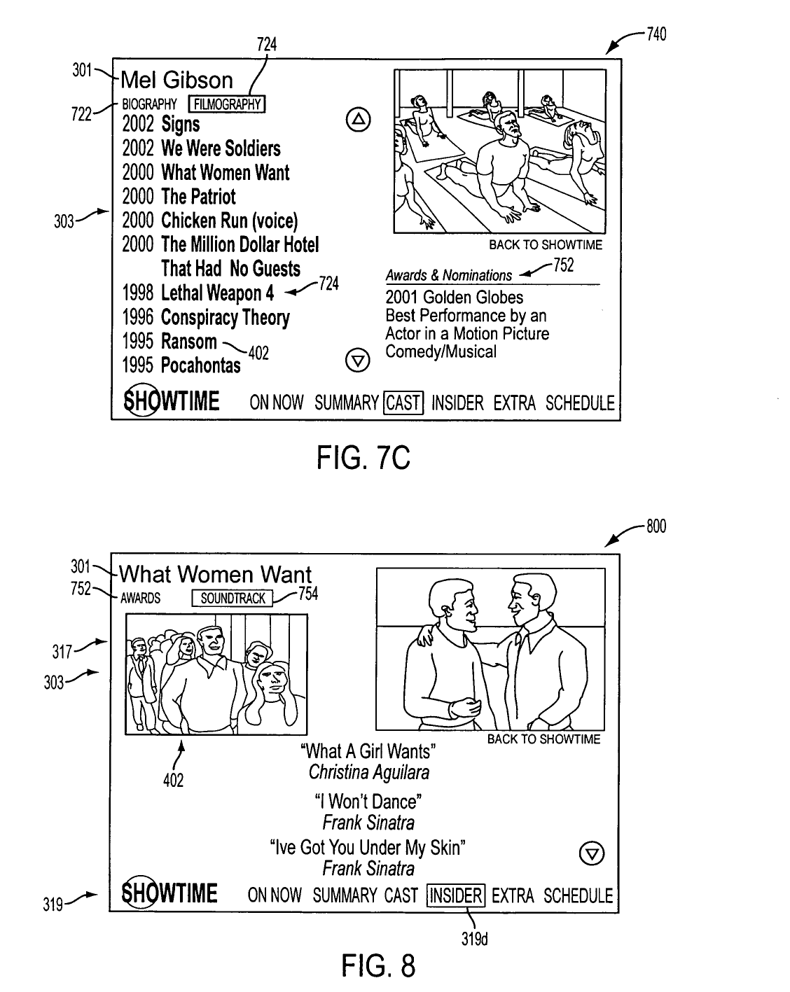

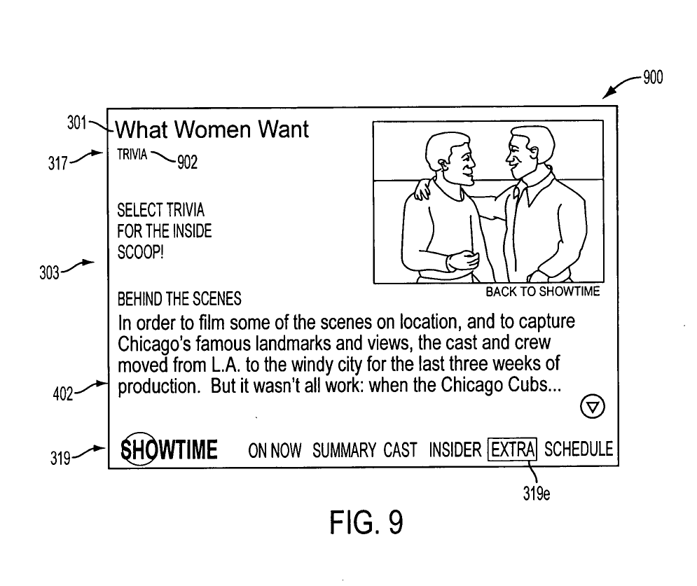

FIG. 4 depicts exemplary insider screen 400 including an exemplary three section group of lists of additional information about the program as well as, e.g., access to soundtrack information 454, etc., in an exemplary embodiment of the present invention. The insider button 319d in primary navigation bar 319 may allow the viewer to obtain additional, in-depth information about a program, or movie, such as, e.g., but not limited to box office, release date, official web site(s), filming locations, soundtrack listing, behind the scenes, trivia, and awards, etc. Examples of a two section insider screen 740, 760, is shown in FIG. 7C providing an exemplary filmography, or other information relating to the on demand programming being accessed. The insider information may be organized into categories. The categories may include, e.g., but not limited to, soundtrack, behind the scenes, awards, and others. Insider screen 400 may provide on a secondary navigation bar 317 with different categories of additional insider information available such as, e.g., awards 452 and soundtracks 454. Each category may be assigned a respective button, which may link to the appropriate information. The various insider information about the movie can be displayed in text portion 402 of content area 303 as shown (the text portion may include scrolling if needed). Screen 400 may display a general insider screen that may be presented to the viewer when they first enter the insider area. The information in content area 303 may provide general background information related to the on demand programming being viewed or otherwise accessed. Selection of the awards button 452 may display awards information for the movie. Selection of the soundtrack button 454 may provide access to soundtrack screen 800 of FIG. 8. The insider screen may provide behind the scene information about the movie, such as filming anecdotes and the like. The insider button 319d in primary navigation bar 319 may allow the viewer to obtain additional, in-depth information about the on demand program being accessed. such as, e.g., but not limited to box office information such as, e.g., release date, opening weekend revenue, gross revenue, official web site(s), filming locations (as shown in FIG. 4), soundtrack listing (FIG. 8), behind the scenes, trivia (see FIG. 9), and awards (not shown), etc. An example of a two section insider screen 740, appears in FIG. 7C.

FIG. 5A depicts an exemplary postcard screen 500 illustrating an exemplary postcard that a viewer may request to send information related to on demand programming from a content provider to the viewer's email address according to an exemplary embodiment of the present invention. Postcard screen 500 may be reached as a result of a viewer's selection of button from window 310. As shown, the screen 500 may include, e.g., an animation in image 318, identifying fields 502 (e.g., a name, an email address, a zip code, or other location identifier, etc., where one or more fields may be required), an opt in/out button 504, a set button 506 which may be used to complete the email, and a cancel button 508 which may be used to cancel sending the email. A play or record option may also be provided for available programming services, for example, on demand programming services available via video on demand (VOD) or subscription VOD (SVOD), programming services accessible on a DVR, or accessible via data stored or cached on a hard drive at the client device, or otherwise, and available for play. A button may be provided to play or record, depending on whether the viewer has a DVR or other recording device that the system can tie into. An application programming interface (API) may be provided that may allow the DVR to be queried to determine its capabilities. In an exemplary embodiment, if a recording device is located, then the button may be made to record, alternatively the button may read or play the programming.

FIG. 5B depicts another exemplary TV postcard screen 510 illustrating an exemplary TV postcard that may be sent by one viewer to another user at an email address according to an exemplary embodiment of the present invention. TV postcard screen 510 may be reached as a result of a viewer's selection of TV postcard button 308. As shown, the screen 510 may include, e.g., an animation in image 318, sender and recipient identifying fields 502, 504 (each including, e.g., a name, an email address, a zip code, or other location identifier, etc., where one or more fields may be required), a text field 514, which may include optionally prefilled out text 516, a send TV postcard button 518, and a cancel button 508. Once the send button 518 is selected, then a sent message 522 may be shown as illustrated in screen 520 of FIG. 5C, where send button 518, and cancel button 508 may be no longer functional, and may be grayed out. In an exemplary embodiment the email may allow the recipient of the email to purchase or access the on demand programming content. In one exemplary embodiment, the recipient of the email may be able to access the content at a discount. In another exemplary embodiment the sender of the email may receive a discount or other benefit for having recommended the programming to the recipient of the email, if as a result of receiving the email, the recipient purchases/accesses the on demand programming.

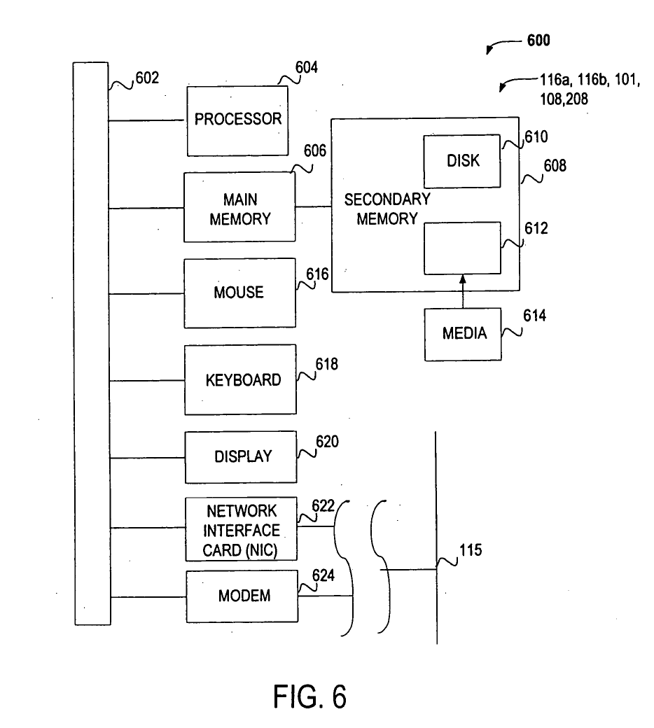

FIG. 6 depicts an exemplary computer system that may be used in implementing an exemplary embodiment of the present invention. Specifically, FIG. 6 depicts an exemplary embodiment of a computer system 600 that may be used in computing devices such as, e.g., but not limited to, client or server devices including devices 116a, 116b, 101, 108, 208, etc. according to an exemplary embodiment of the present invention. FIG. 6 depicts an exemplary embodiment of a computer system that may be used as client device 102, or a server device 104, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 600 is shown in FIG. 6, depicting an exemplary embodiment of a block diagram of an exemplary computer system useful for implementing the present invention. Specifically, FIG. 6 illustrates an example computer 600, which in an exemplary embodiment may be, e.g., (but not limited to) a personal computer (PC) system running an operating system such as, e.g., (but not limited to) MICROSOFT® WINDOWS® NT/98/2000/XP/CE/ME/etc. available from MICROSOFT® Corporation of Redmond, Wash., U.S.A. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 600 is shown in FIG. 6. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, etc., may also be implemented using a computer such as that shown in FIG. 6.

The computer system 600 may include one or more processors, such as, e.g., but not limited to, processor(s) 604. The processor(s) 604 may be connected to a communication infrastructure 606 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 600 may include a display interface 602 that may forward, e.g., but not limited to, graphics, text, and other data, etc., from the communication infrastructure 606 (or from a frame buffer, etc., not shown) for display on the display unit 630.

The computer system 600 may also include, e.g., but may not be limited to, a main memory 608, random access memory (RAM), and a secondary memory 610, etc. The secondary memory 610 may include, for example, (but not limited to) a hard disk drive 612 and/or a removable storage drive 614, representing a floppy diskette drive, a magnetic tape drive, an optical disk drive, a compact disk drive CD-ROM, etc. The removable storage drive 614 may, e.g., but not limited to, read from and/or write to a removable storage unit 618 in a well known manner. Removable storage unit 618, also called a program storage device or a computer program product, may represent, e.g., but not limited to, a floppy disk, magnetic tape, optical disk, compact disk, etc. which may be read from and written to by removable storage drive 614. As will be appreciated, the removable storage unit 618 may include a computer usable storage medium having stored therein computer software and/or data.

In alternative exemplary embodiments, secondary memory 610 may include other similar devices for allowing computer programs or other instructions to be loaded into computer system 600. Such devices may include, for example, a removable storage unit 622 and an interface 620. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 622 and interfaces 620, which may allow software and data to be transferred from the removable storage unit 622 to computer system 600.

Computer 600 may also include an input device such as, e.g., (but not limited to) a mouse or other pointing device such as a digitizer, and a keyboard or other data entry device (none of which are labeled).

Computer 600 may also include output devices, such as, e.g., (but not limited to) display 630, and display interface 602. Computer 600 may include input/output (I/O) devices such as, e.g., (but not limited to) communications interface 624, cable 628 and communications path 626, etc. These devices may include, e.g., but not limited to, a network interface card, and modems (neither are labeled). Communications interface 624 may allow software and data to be transferred between computer system 600 and external devices.

In this document, the terms “computer program medium” and “computer readable medium” may be used to generally refer to media such as, e.g., but not limited to removable storage drive 614, a hard disk installed in hard disk drive 612, and signals 628, etc. These computer program products may provide software to computer system 600. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

In yet another exemplary embodiment, the invention may be implemented using a combination of any of, e.g., but not limited to, hardware, firmware and software, etc.

FIG. 7A depicts an exemplary movie summary screen 700 providing exemplary summary information related to on demand programming being viewed, according to an exemplary embodiment of the present invention. Primary navigation bar 319 may also allow the viewer to view a summary screen 700 for a movie or episodic program being viewed or otherwise accessed by selecting summary screen button 319b. The summary screen 700 may provide the viewer with an overview of the program being viewed or otherwise accessed and all pertinent data such as, e.g., but not limited to, rating, running time, date released, advanced program information, etc. The summary screen 700 may include, e.g., text 402, scrollbars 404, image 318, and title 301 in content area 303, and PIP-window 302. In addition, the viewer may obtain additional information on the movie or series by highlighting and selecting any of the buttons on navigation bar 319.

FIG. 7B depicts an exemplary movie cast screen 710 according to an exemplary embodiment of the present invention. Primary navigation bar 319 may also provide a cast button 319c. By selecting the cast button 292, a movie cast screen may be presented relating to the on demand programming being accessed. The movie cast screen may provide information relating to actors 712 in the on demand programming, in this case, a movie, the movie's characters 714, and a biography 720 or filmography 740 for an actor. An example of a movie cast screen 710 is shown in FIG. 7B. The title 301 of the movie is shown in content area 303. FIG. 7B shows the cast screen 710 for the movie “What Women Want.” A list of the actors 712 in the movie along with their associated characters 714 may also be provided in content area 303. If an actor has an associated biography 720 or a filmography 740, a more link 716 may be provided next to that actor name 712. The viewer can select the more link 716 in order to access more information regarding that actor 712. If the cast button 319c is selected from the primary navigation bar 319 on the on now screen 310, 320, a cast screen 710 as shown in FIG. 7B may be provided. The cast screen 710, an example of which is shown in FIG. 7B, lists the actors and the roles they play in the program, in the exemplary embodiment, a non-series on demand programming, in this case a movie. Had the information on the cast screen 710 been for a series, the cast list could be made, e.g., non-episode specific or specific to an episode, in an exemplary embodiment. In the example shown, the cast for the movie “What Women Want” is provided. A list of actors 712 and the corresponding characters 714 that the actors portray may be displayed in content area 303. If an actor or character has additional information available, such as, e.g., an associated biography or filmography, or character description, a more link 716 may be provided for that actor or character. Selecting the more link 716 may display the actor's biography (not shown) or filmography (see FIG. 7C below) for the selected actor.

FIG. 7C depicts an exemplary two section information screen providing an exemplary filmography screen 740 according to an exemplary embodiment of the present invention. A filmography may include in content area 303, e.g., a list of films in which the corresponding actors starred and additional information such as, e.g., a year of the movie's release, any awards won or nominations for the actor, etc.

FIG. 8 depicts an exemplary insider screen 800, including exemplary additional information about the program such as, e.g., but not limited to, soundtrack information, etc., in an exemplary embodiment of the present invention. Screen 400 of FIG. 4 shows an insider screen with exemplary three sections. Selection of the soundtrack button 752 from FIG. 7C, or 454 from FIG. 4, may provide access to soundtrack screen 800 of FIG. 8.

The songs of the soundtrack, instrumentals, and artists may be listed, as well as, e.g., further information such as, e.g., a way to purchase a copy of the soundtrack, to download the audio, or music video, etc., may be provided in exemplary embodiments. FIG. 9 depicts an exemplary trivia screen 900 for accessing an exemplary interactive enhanced trivia application according to an exemplary embodiment of the present invention. Trivia information about, e.g., the movie, programming, or actors, may be included in content area 303. A quiz button 904 (not shown) may be provided to link to a quiz such as, e.g., exemplary quiz application screen 910 (not shown). Screen 900 may provide access to interactive enhanced applications according to an exemplary embodiment of the present invention. Screen 900 may display exemplary behind the scenes information and other information in textual area 402. In an exemplary embodiment, trivia button 902 may be used to link to trivia information related to the on demand programming.

Accordingly, a viewer can use the interactive interface to gain a vast amount of information regarding programs, including subject matter thereof and movies being viewed or otherwise accessed including, e.g., the cast and characters, soundtrack, etc. of the movies and programs, such as, e.g., biographies, filmographies, awards, trivia, quizzes, and other in depth information. The interactive interface provides a convenient and easy to use interface to navigate available information, as well as to record programs and set reminders. A viewer may obtain programming information, added value content, initiate recording of on demand programs, and access to subscription activation via the interactive interface.

The programming services may be provided on demand using, e.g., but not limited to, VOD and SVOD, and programming accessible from DVR, or other on demand viewing system. The programming accessible via DVR may include content distributed to a DVR, and content downloaded by a user to the user's DVR.

Sometimes a program may have different points in the program where enhancements may be synchronized, or may be locked to the program's timecode. Another scenario may include where triggers are pre-encoded. In an exemplary embodiment, the present invention may provide interactive content that may be synchronized with the viewing experience. The synchronized information may, in an exemplary embodiment, be embedded in a trigger in the on demand programming to allow access to the interactive content. The synchronized content may also be provided by embedding a trigger in a video file of the on demand programming that may communicate at various points in the video with an external interactive television (ITV) application to initiate a certain action, such as, e.g., but not limited to, linking to an external database, or content. The synchronized information may also be accessed by reference to a reference point in a video file, or an elapsed time from the program start, creating, e.g., a relative time reference point. The synchronized content may be provided in any of various conventional manners, such as, e.g., by use of a two screen experience, e.g., accompanied by a playlist, by entry of a link, by access of a bar code or other method or other device to trigger access to content. In an exemplary embodiment, the time reference may be provided in the video file, or an elapsed time from the program start may be used and the synchronized information may be accessed in accord with a playlist of a nmber of events; and each of the events may be accessed according to the time reference, or the elapsed time from start, as required by the playlist. In another exemplary embodiment, the synchronized interactive content information may be embedded in an application in a video signal (including, e.g., but not limited to, an MPEG, MPEG2, MPEG4, Windows Media, Real Media, or other video signal or media stream) of the on demand programming.

While various exemplary embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents. While this invention has been particularly described and illustrated with reference to exemplary and preferred embodiments, it will be understood to those having ordinary skill in the art that changes in the above description or illustrations may be made with respect to formal detail without departing from the spirit and scope of the invention.

What is claimed is:

1. A method for providing programming information, comprising:
receiving a request for interactive content related to on demand programming; and
providing an interactive interface including said interactive content relating to said on demand programming while a user is accessing said on demand programming.

2. The method according to claim 1, wherein said receiving comprises:
receiving said request for interactive content relating to said on demand programming, said on demand programming comprising at least one of a video on demand (VOD), or subscription VOD on demand programming.

3. The method according to claim 1, wherein said receiving comprises:
receiving said request for interactive content relating to said on demand programming, said on demand programming comprising programming accessed from a digital video recorder (DVR).

4. The method according to claim 3, wherein said programming accessed from said DVR comprises at least one of:
programming delivered to said DVR in a pre-cached video on demand (VOD) environment; or
programming recorded to a DVR by a consumer.

5. The method according to claim 1, wherein said receiving comprises:
receiving said request for interactive content relating to said on demand programming, wherein said on demand programming comprises programming facilitated by at least one of:
a client cache,
a media stream,
a digital video server,
a client stored, or
a digital video recorder (DVR).

6. The method according to claim 1, wherein said providing comprises:
providing said interactive interface including said interactive content relating to said on demand programming, said interactive content being viewed in at least one of:
a full screen, or
an overlay.

7. The method according to claim 1, wherein said providing comprises:
providing said interactive interface including said on demand programming wherein said programming is at least one of:
hidden,
fullscreen, or
in picture in picture (PIP).

8. The method according to claim 1, wherein said providing comprises:
providing said interactive interface including said interactive content relating to said on demand programming while said on demand programming is at least one of being viewed, being experienced, being fast forwarded, being rewound, or being paused.

9. The method according to claim 1, wherein said providing comprises:
providing said interactive interface including said interactive content comprising interactive content that comprises information at least one of synchronized or not synchronized with said on demand programming.

10. The method according to claim 1, wherein said providing comprises:
providing said interactive interface including said interactive content comprising information relating to at least one of said on demand programming, a programming service, other on demand programming, a programming scene, or a point in time.

11. The method according to claim 9, wherein said providing said interactive content comprising said synchronized information comprises embedding a trigger in said on demand programming to access said interactive content.

12. The method according to claim 11, wherein said providing comprises embedding a trigger in a video file of said on demand programming that communicates at various points in said video with an external interactive television (ITV) application to initiate a certain action.

13. The method according to claim 9, wherein said providing said interactive content comprising said synchronized information comprises accessing said interactive content based on at least one of a time reference in a video file, or an elapsed time from program start.

14. The method according to claim 13, wherein said providing comprises providing an interactive application adapted to read at least one of said time reference in said video file, or said elapsed time from program start; and adapted to read a playlist of a plurality of events; and wherein said accessing comprises executing an event of said plurality of events associated with said time reference, or said elapsed time.

15. The method according to claim 9, wherein said providing said interactive content comprising said synchronized information comprises embedding an application in a video signal of said on demand programming.

16. The method according to claim 1, wherein said providing said interactive content comprises providing enhanced information content comprising at least one of:
providing a biography of a person associated with said on demand programming;
providing a filmography of a person associated with said on demand programming;
providing a character description of a character of said on demand programming;
providing award information relating to said on demand programming;
providing a soundtrack of said on demand programming;
providing audio information relating to at least one of said on demand programming, service, or network;
providing video information relating to at least one of said on demand programming, service, or network;
providing information relating to subject matter of said on demand programming being accessed;
providing information relating to a network;
providing information relating to a package of networks;
providing information relating to a programming service;
providing information relating to a promotion;
providing promotional information for a nonsubscriber relating to said on demand programming; or
offering programming to a nonsubscriber.

17. The method of claim 1, wherein said providing said interactive content comprises:
providing promotional information targeted based on subscription status.

18. The method of claim 17, wherein said providing promotional information comprises:
identifying a subscription status of a viewer;
allowing the viewer to access said interactive content in accordance with said subscription status;
presenting an offer to a nonsubscriber; and
receiving an order accepting said offer from said nonsubscriber.

19. The method of claim 1, wherein said providing said interactive content comprises:
promoting at least one of other content, another program, an on demand service, a network, a package of networks, a feature, or a promotion, from said on demand programming.

20. The method of claim 1, wherein said providing said interactive content comprises:
providing targeted interactive content to a viewer of said on demand programming.

21. The method of claim 1, wherein said accessing said on demand programming comprises at least one of:
viewing said on demand programming;
engaging in a viewing experience of said on demand programming;
fast forwarding said on demand programming;
rewinding said on demand programming;
pausing said on demand programming; or
playing said on demand programming.

22. The method according to claim 1, wherein said providing said interactive content comprises providing interactive components comprising at least one of:
providing trivia relating to said on demand programming;
providing a quiz relating to said programming;
providing a postcard generator related to said on demand programming;
providing polling relating to said on demand programming; or
providing gaming relating to said on demand programming.

23. The method according to claim 1, wherein said providing said interactive content comprises providing an enhanced audio video (A/V) experience comprising at least one of:
providing at least one of a video track or an alternate video track, said alternate video track comprising at least one of an alternate camera angle track, an alternate resolution track, an alternate video special effects track, a subtitle video track, or an alternate ratings video track for said on demand programming;
providing at least one of an audio track, or an alternate audio track, said alternate audio track comprising at least one of an alternate language audio track, an alternate audio special effect track, or an alternate audio format track, for said on demand programming;
providing a promotional audio/video track targeted based on subscription status of a viewer;
providing a commentary of a director relating to said on demand programming; or
providing deleted scenes relating to said on demand programming.

24. The method according to claim 1, further comprising:
sending a playlist to a client to enable a two-screen experience synchronizing information between said client or said programming.

25. The method according to claim 24, wherein said sending said playlist to said client comprises:
sending said playlist to at least one of: a tablet, a personal computer (PC), a handheld, a personal digital assistant (PDA), a mobile phone, a remote screen, a remote control, or a browser.

26. The method according to claim 24, wherein said sending a playlist comprises:
sending an updated playlist based on at least one of a state of play or pause of said on demand programming; or a timecode in said on demand programming.

27. The method according to claim 1, wherein said receiving a request comprises:
receiving a request from a user wherein said user comprises at least one of a subscriber or a nonsubscriber.

28. The method according to claim 1, wherein said providing said interactive content comprises:
providing said interactive content targeted based on said on demand programming being accessed.

29. The method according to claim 1, wherein said providing said interactive interface comprises:
providing an interactive interface, for nonsubscribers comprising:
presenting a subscription offer; and
receiving a subscription order in response to said subscription offer.

30. A system for providing programming information, comprising:
an interactive interface adapted to receive a request for interactive content related to on demand programming; and adapted to provide said interactive content relating to said on demand programming while a user is accessing said on demand programming.

31. A system for providing programming information, comprising:
means for receiving a request for interactive content related to on demand programming; and
means for providing an interactive interface including said interactive content relating to said on demand programming while a user is accessing said on demand programming.

32. A machine readable medium that provides instructions which when executed by a computing platform, cause said computing platform to perform operations comprising a method of providing programming information, comprising:
receiving a request for interactive content related to on demand programming; and
providing an interactive interface including said interactive content relating to said on demand programming while a user is accessing said on demand programming.
